(19) United States
(12) Patent Application Publication
(10) Pub. No.: US 2010/0029353 A1
(43) Pub. Date: Feb. 4, 2010

(54) Electronic teaching game

(76) Inventor: Jerald L. Donaldson, San Diego, CA (US)

Correspondence Address: CHARMASSON, BUCHACA & LEACH, LLP, 2635 Camino Del Rio South, Suite 102, SAN DIEGO, CA, 92108, US

(21) Appl. No.: 12/184,751

(22) Filed: Aug. 1, 2008

(51) Int. Cl. G09B 19/22

(52) U.S. Cl. 463/9

(57) ABSTRACT

A procedure and device for electronically teaching the components of a structure and their assembly within a given framework. The procedure is exemplified by an electronic game in which fractions of a crossword puzzle array are filled by selecting words from a displayed list. Mouse-clicking on a letter of a word already entered in a fractional array causes the display of a clue pertaining to the corresponding crossword. Once properly filled, the fractions of the array can be arranged together into a complete array. When all the words have been entered, the operator is asked to match a set of clues with the entered words. The game may be played by several persons. The system keeps individual competitive performance scores.

### FIELD OF THE INVENTION

The instant invention relates to interactive teaching devices, and more specifically to computerized teaching games.

### BACKGROUND

The popularity among adolescents of electronic games that are played on computerized stations has lead to the development of various teaching games.

In general, these teaching tools consist in displaying the item to be learned or part of it, generating questions or clues that characterize the answers, then keeping scores based on the right and wrong answers provided by the operator.

The teaching efficacy of such games is usually enhanced by attractive graphics, in-image animation and sound synchronization.

The instant invention results from an attempt to further improve the attractiveness and fascination of electronic teaching aides and to expand their utility.

### SUMMARY

Most physical devices and mental constructs may be analyzed and broken down into discrete, multi-component elements and their linking components.

For example, an automobile engine can be decomposed into parts and the nuts, bolts, brackets and other fasteners that help hold these parts together.

The structure of a molecule can be shown as a framework of chemical elements linked by valence-determined bonds.

A poem consist of words ordained according to morphological and syntactic rules as well as rhythmic conventions.

The invention may be used to teach the composition of a device or construct and the arrangement of its components by practicing the construction and analysis in an entertaining context.

An exemplary embodiment of this invention focuses on a crossword puzzle game with physical and mental aspects of a diversified example of the invention potentials. In order to emphasize the teaching capability of the game over its entertainment value, it is played in a reverse fashion from conventional crossword puzzles in that the player starts with a listing of all applicable words and must attempt to connect each one with the appropriate space in the crossword array or with a characterizing clue.

In some embodiments there is provided a device for teaching the assembly of a multi-component structure which comprises: a cell framework sized and configured to hold a plurality of multi-component elements in a preset pattern; a set of multi-component elements sized and configured to occupy said framework, each of said elements including at least one link component configured to connect to at least one other of said elements; means for selecting one of said elements from said set; and, means for entering said selected element in said framework in accordance with said pattern.

In some embodiments, at least two of said elements when held in said framework share at least one of their link components.

In some embodiments the framework comprises blocks of adjacent cells each dimension to precisely nest one of said elements.

In some embodiments the framework further comprises a multi-dimensional matrix of cells, a plurality of said cells being sized to accept a single one of said link components.

In some embodiments each of said link components consist of a link component of a different element.

In some embodiments the device further comprises: a list of characterizations, each of said characterizations being related to one of said elements; and, means for grouping characterizations related to elements sharing one of said link components.

In some embodiments the device further comprises means for identifying in said set an element related to a first one of said characterizations.

In an exemplary embodiment of the invention, the framework consists of a cross-puzzle array, each of said elements consists of a word and each of said components is a letter.

In some embodiments the framework is a two dimensional array.

In some embodiments the device further comprises: means for displaying fractions of said array and sets of said characterizations; means for selectively filling said fraction with a plurality of selected ones of said elements; and, means for combining filled ones of said fractions.

In some embodiments the means for displaying, means for storing, mean for filling, and means for combining comprise a computerized station including a micro processor, a storage memory, an entry device, a display screen, and a plurality of computer program modules.

In some embodiments said set of elements comprises “X” and “Y” elements, said “X” elements configured to be entered horizontally in said array, and said “Y” elements configured to be entered vertically in said array.

In some embodiments the program modules comprises: a routine for displaying a first subset of “X” elements; and, a routine for displaying a second subset of “Y” elements.

In some embodiments one of said program modules further comprises: a routine for selecting one element in one of said subsets; and, a routine for placing and displaying said selected element in one of said fractions.

In some embodiments the program modules further comprise: a routine for displaying a characterization related to a cost element upon selection of a component of an element entered in said fraction.

In some embodiments the program modules further comprise a routine for merging said fractions together.

In some embodiments the program modules further comprise a routine for marking border cells in said array.

In some embodiments the program modules further comprise: a routine for displaying one of said characterization along a filled out array; and, a routine for measuring the time taken by an operator to select the element related to said characterization.

In some embodiments the program modules further comprise: routines for recognizing a plurality of operators; and, routines for competitively accumulating performance scores related to said operators.

In some embodiments there is provided a method for running a crossword puzzle game, wherein said method comprises: providing to a player with a list of cross words and down words; providing at lest one fraction of a crossword array, said fraction having at least two locations dimensioned to accept one cross word and at least one intersecting down word; upon selection of a first of said locations by a player, providing a clue characterizing a first of said word fitting said first location; upon selection by a player of said first word from said list, entering said first word into said first location; upon selection of a letter of said first word by a player, providing a clue characterizing a second word from said list, said second word crossing said first word and sharing said letter with said first word; and upon selection by a player of said second word from said list, entering said second word into said fraction.

### BRIEF DESCRIPTION OF THE DRAWINGS

FIG. 1 is a block diagram of the computerized station upon which a game in accordance with the invention may be practiced;

FIG. 2 is a table listing the elements or words, and their characterizations or clues;

FIG. 3 is a table listing the elements or words, and their characterizations or clues;

FIG. 4 is a flow chart of the process for filling the game array;

FIG. 5 is a flow chart of the recapitulation procedure; and

FIGS. 6-11 illustrate various array-filling moves.

### DESCRIPTION OF THE EXEMPLARY EMBODIMENT OF THE INVENTION

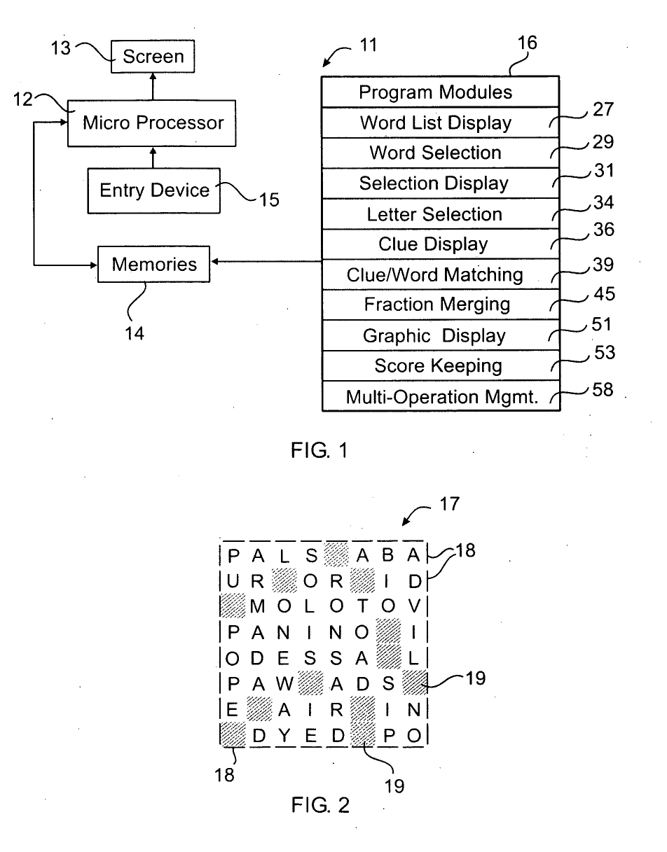

Referring now to the drawing there is shown an electronic training game device according to the invention. This exemplary embodiment of the invention revolves around a crossword puzzle game that may be practiced on a computer station 11 illustrated in FIG. 1.

This computer station may be a standard personal computer comprising a microprocessor 12, a display screen 13, one or more memories 14, and at least one entry device 15 such as a mouse, thumbwheel, finger pad, or keyboard, and a series of special and specific program routines 16 that direct the operation of the station in accordance with the invention.

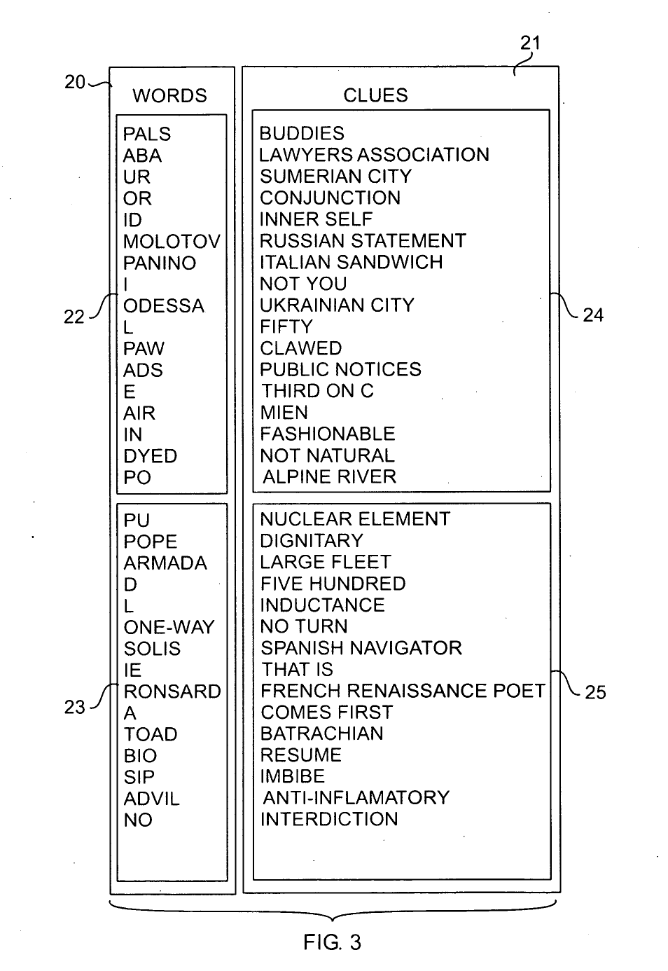

Stored in the computer memory 14 is the crossword puzzle two dimensional array 17 of FIG. 2 filled in with word elements according to a predetermined cross pattern. It should be noted that a three-dimensional array could alternately be used. Every square or cell that is positioned along an edge of the array is marked with a short bar 18. These bars together form a frame surrounding the entire array. As in most crossword arrays, some cells 19 are blanked out. Any letter in a word that is not completely framed by one or more of other letters in the same word, one or more blanked cells, or one or more edge bars, act as a link component common to both a horizontal word and a vertical word.

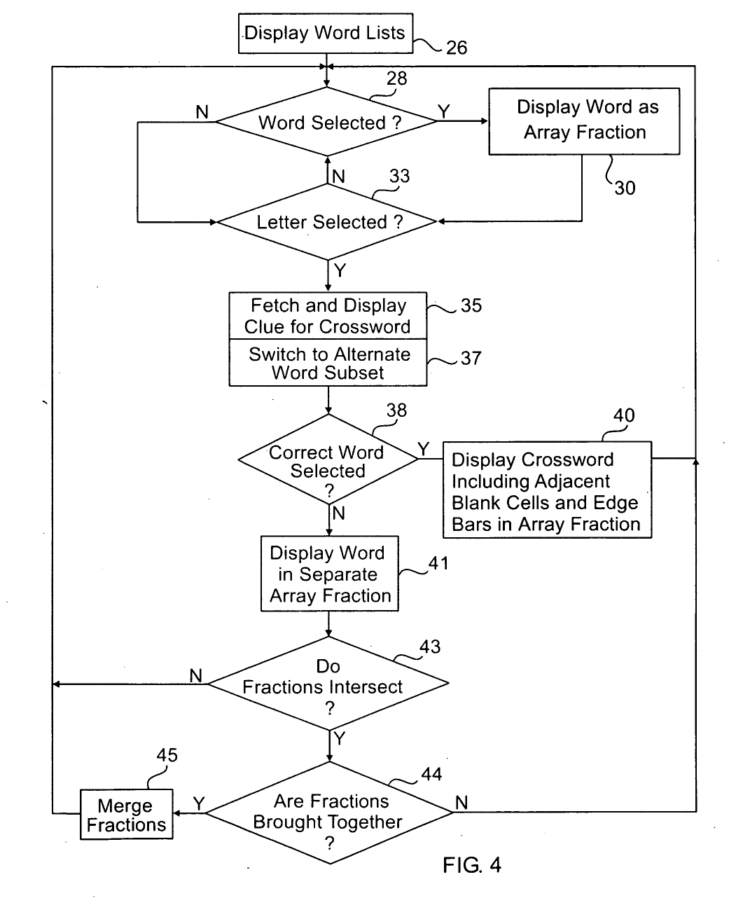

As shown in FIGS. 1-3, the memories 14 hold a list of elements or words 20 which match the array 17 and a list of descriptive characterizations or clues 21 related to those words. The word list is divided into a subset 22 of a horizontal, across or “X” elements and a subset 23 of a vertical, down or “Y” elements. Similarly, the list of clues 21 is divided into a subset 24 of horizontal word characterizations and a subset 25 of vertical word characterizations.

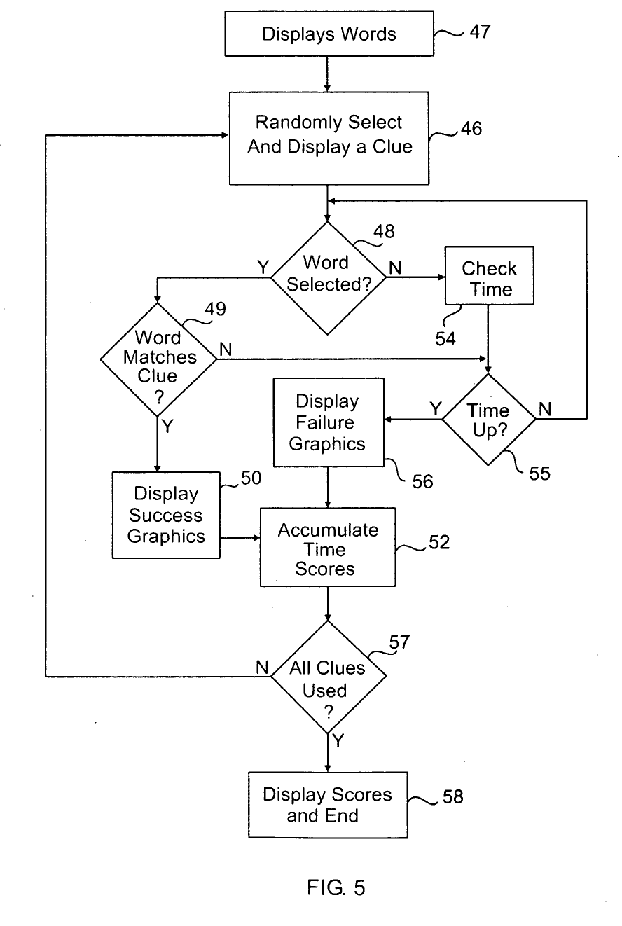

As illustrated in FIG. 4, the game begins with the display 26 of one of the two subsets 22 or 23 of words under the Word List Display program routine 27. The program then waits 28 for the selection of a word from the displayed subset by a player. This selection, as well as other moves throughout the game may be done, for instance, by mouse-clicking on the desired element. Every time a word is selected, the alternate across or down subset is displayed replacing the one from which the word was fetched. The selection is directed by the Word Selection routine 29. The operator can switch between subsets by mouse-clicking on a non-word portion of displayed subset.

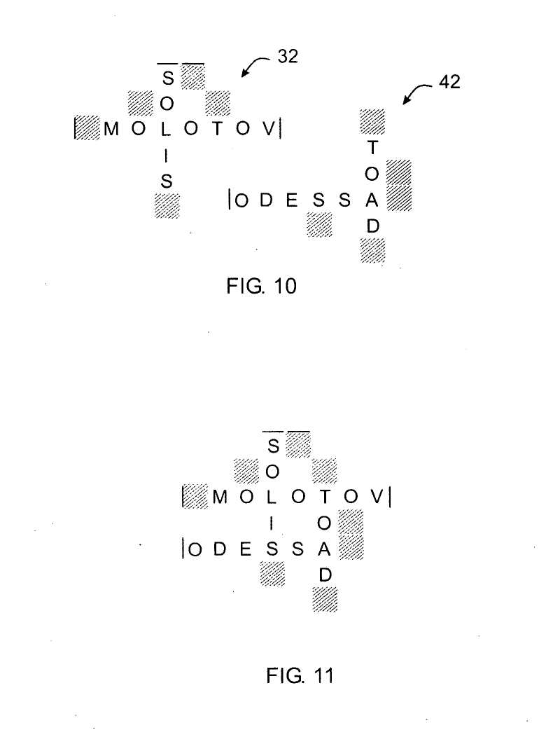

As soon as a word is selected, it is displayed 30 using the Selection Display routine 31 in its appropriate horizontal or vertical orientation, as it would be oriented in the array. In an example of the procedure illustrated in FIG. 6, if the word MOLOTOV is selected, it will be displayed horizontally. It should be noted that since this word is displayed by itself without any intersecting crosswords, it is displayed without its adjacent blanked cells 19 and edge bars 18. This discourages the player from randomly selecting a number of words and visually connecting array fractions without answering clues.

At this point, the player has the option to either select one of the components or letters in the displayed word and be given a clue as to the intersecting crossword, or to select another word from the then-displayed subset list.

Once a word component or letter is selected 33 out of the word in the fractional array, under the Letter Selection routine 34, the selected letter is highlighted, the program fetches and displays 35 the clue out of the subset 24, 25 that relates to the appropriate crossword under the program Clue Display routine 36. At the same time, the alternate word subset is also placed 37 on the screen.

Going back to the example, if the first “O” of the word MOLOTOV is selected, the clue NO TURN is displayed. If, responding to the clue, the player selects 38 the word element ONEWAY, the program routine Clue/Word Matching 39 immediately adds it 40 to the already displayed fractional array as shown in FIG. 7. Now that more than one word appears as part of the array fraction any adjacent blank squares 19 and border lines 18, are displayed 30 using the Selection Display routine 31.

If, in lieu of selecting one of the letters in the already displayed word in the fractional array 32, the player picks up another word from the displayed subset, that word is displayed in a separate fraction of the array without adjacent blank squares nor border lines being shown.

For example, if the player, noticing that the already selected word MOLOTOV contains three “Os”, clicks on the word TOAD which, although it does cross the word MOLOTOV, it is not selected in response to a clue. Therefore it is displayed in a separate fraction 41 of the array without its adjacent blanked cells 19 and edge bar 18, as shown in FIG. 8, and spaced apart from the other displayed array fraction 32. If from the two fractional arrays of FIG. 8 on the screen it appears that there is no intersection between the words in the respective fractions, the player is left with either selecting another word from one of the word subsets, or try to expand one of the array fractions.

If she selects the letter “A” in the word TOAD, and correctly responding to the resulting clue UKRAINIAN CITY, picks ODESSA out of the horizontal subset 22, that word is immediately entered under Clue/Word Matching routine 39 into the fractional array 42 in its proper position as shown in FIG. 9. Note, any adjacent blank squares 19 and border lines 18, that are part of the array fraction 42 are now displayed 40 using the Selection Display routine 31.

Similarly, the operator correctly expands the fractional array 32 containing MOLOTOV by selecting the “L” and correctly answering the clue SPANISH NAVIGATOR with the word SOLIS, as shown in FIG. 10.

The operator can now suspect that the two displayed fractions of the array mesh together may have a common interface 43. By clicking on one of the two array fractions and dragging it 44 toward the other, the two displayed fractions automatically are merged under the Fraction Merging routine 45 as illustrated in FIG. 11.

The game can be brought to a successful conclusion by skillfully repeating some of the above described moves.

In a particularly instructive manner, the device allows for a recapitulation of the clue and word matching in a competitive setting that is particularly entertaining and enhancing of the vocabulary skills of the players.

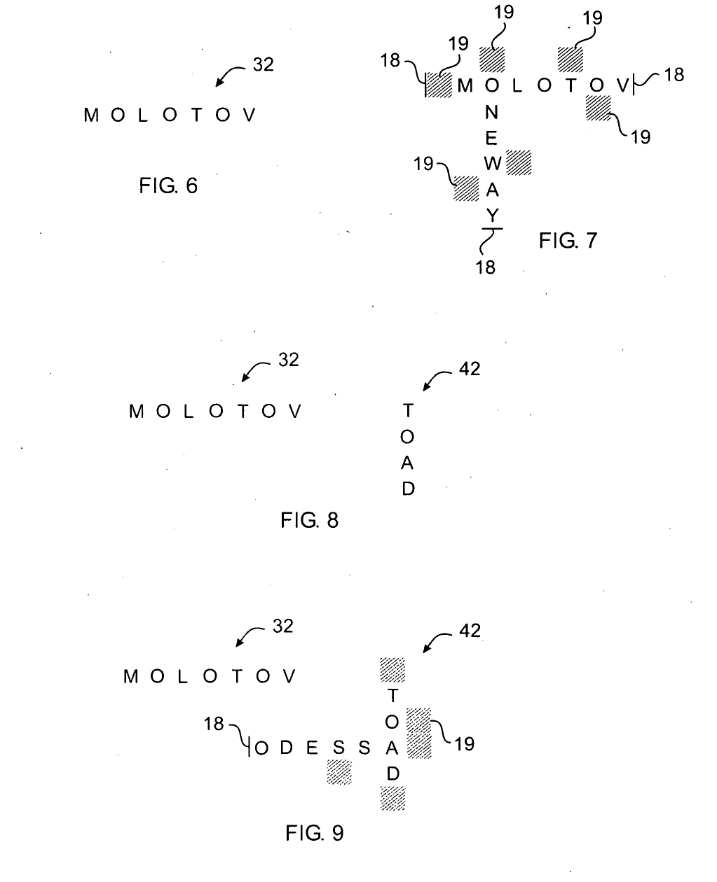

The recapitulation process illustrated in FIG. 5 begins with the random selection 46 of a clue from the entire list of clues appears on the screen 13. The whole list of words 20 is displayed 47 along with the randomly selected first clue. The player is then invited to make a selection that matches the clue. As soon as a word is selected 48, the program checks to see if it matches 49 the clue under the Clue/Word Matching routine 38. If it does, a success graphic is displayed 50 under one of several Graphic Display routines 51 and the score is kept 52 of the time taken for the player to find the correct matching word according to the Score Keeping routine 53. While the player is making her choice, her hesitation time is calculated 54 and checked 55 against a failure limit. The wait continues until the limit is reached. If the time limit is reached, a failure graphic is displayed 56, and the next randomly selected clue is displayed. In the case of a correct or wrong answer, scores are accumulated for each player 51. Once all the clues have been dealt with 57, the player's scores are displayed 58 and the recapitulation session is ended.

A Multi-operator Management routine 59 is used to keep separate scores in a competitive context.

It shall now be understood that the above embodiment can be adapted to other multi-element structures such as mechanical assemblies, complex molecules or chemical formulations, and computer programs, to name a few.

For example, in the mechanical setting, the cell framework can be adapted to accept an automobile engine assembly in a preset pattern, where engine parts make up the elements which occupy the framework. Each engine part element will have multiple components, some of which link to the linking components of other elements. For example, a piston element has a piston ring linking component which links with the cylinder wall linking component of the engine block element.

While the exemplary embodiments of the invention have been described, it should be understood that modifications can be made and other embodiments may be devised without departing from the spirit of the invention and the scope of the appended claims.

What is claimed is:

1. A teaching device which comprises:
a cell framework sized and configured to hold a plurality of multi-component elements in a preset pattern;
a set of multi-component elements sized and configured to occupy said framework, each of said elements including at least one link component configured to connect to at least one other of said elements;
means for selecting one of said elements from said set; and
means for entering said selected element in said framework in accordance with said pattern.

2. The device of claim 1, wherein at least two of said elements when held in said framework share at least one of their link components.

3. The device of claim 2, wherein said framework comprises blocks of adjacent cells each dimension to precisely nest one of said elements.

4. The device of claim 3, wherein said framework further comprises a multi-dimensional matrix of cells, a plurality of said cells being sized to accept a single one of said link components.

5. The device of claim 1, wherein each of said link components consists of a link component of a different element.

6. The device of claim 4, which further comprises:
a list of characterizations, each of said characterizations being related to one of said elements; and
means for grouping characterizations related to elements sharing one of said link components.

7. The device of claim 5, which further comprises means for identifying in said set an element related to a first one of said characterizations.

8. The device of claim 6, wherein said framework consists of a cross-puzzle array, each of said elements consists of a word and each of said components is a letter.

9. The device of claim 5, wherein said framework is a two dimensional array.

10. The device of claim 8, which further comprises:
means for displaying fractions of said array and sets of said characterizations;
means for selectively filling said fraction with a plurality of selected ones of said elements; and,
means for combining filled ones of said fractions.

11. The device of claim 10, wherein said means for displaying, means for storing, mean for filling, and means for combining comprise a computerized station including a micro processor, a storage memory, an entry device, a display screen, and a plurality of computer program modules.

12. The device of claim 11, wherein said set of elements comprises “X” and “Y” elements, said “X” elements configured to be entered horizontally in said array, and said “Y” elements configured to be entered vertically in said array.

13. The device of claim 12, wherein one of said program modules comprises:
a routine for displaying a first subset of “X” elements; and,
a routine for displaying a second subset of “Y” elements.

14. The device of claim 13, wherein:
one of said program modules further comprises:
a routine for selecting one element in one of said subsets; and,
a routine for placing and displaying said selected element in one of said fractions.

15. The device of claim 14, wherein said program modules further comprise:
a routine for displaying a characterization related to a cost element upon selection of a component of an element entered in said fraction.

16. The device of claim 15, wherein said program modules further comprise a routine for merging said fractions together.

17. The device of claim 16, wherein said program modules further comprise a routine for marking border cells in said array.

18. The device of claim 15, wherein said program modules further comprise:
a routine for displaying one of said characterization along a filled out array; and,
a routine for measuring the time taken by an operator to select the element related to said characterization.

19. The device of claim 18, wherein said program modules further comprise:
routines for recognizing a plurality of operators; and,
routines for competitively accumulating performance scores related to said operators.

20. A method, for running a crossword puzzle game, which comprises:
providing to a player with a list of cross words and down words;
providing at lest one fraction of a crossword array, said fraction having at least two locations dimensioned to accept one cross word and at least one intersecting down word;
upon selection of a first of said locations by a player, providing a clue characterizing a first of said word fitting said first location;
upon selection by a player of said first word from said list, entering said first word into said first location;
upon selection of a letter of said first word by a player, providing a clue characterizing a second word from said list, said second word crossing said first word and sharing said letter with said first word; and
upon selection by a player of said second word from said list, entering said second word into said fraction.
